(19) United States
(12) Patent Application Publication
(10) Pub. No.: US 2011/0216267 A1
(43) Pub. Date: Sep. 8, 2011

(54) AREA LIGHT SOURCE DEVICE AND LIQUID CRYSTAL DISPLAY DEVICE

(75) Inventors: Hiroyuki Miyamoto, Yasu-shi (JP); Masayuki Shinohara, Nagaokakyo-shi (JP); Kazuhide Hirota, Moriyama-shi (JP)

(73) Assignee: OMRON CORPORATION, Kyoto-shi (JP)

(21) Appl. No.: 13/035,180

(22) Filed: Feb. 25, 2011

(30) Foreign Application Priority Data
Mar. 5, 2010 (JP) 2010-049453

(51) Int. Cl. G02F 1/13357; F21V 7/22

(52) U.S. Cl. 349/62; 362/606

(57) ABSTRACT

An area light source device has a light guide plate having a light incident surface and a light exit surface, wherein the light guide plate spreads light introduced from the light incident surface to substantially the entire light exit surface, and exits the light to outside from the light exit surface, and a linear light source arranged facing the light incident surface of the light guide plate. A diffusion pattern diffuses and reflects the light in the light guide plate within a surface parallel to the light incident surface is formed on the light exit surface of the light guide plate. A deflection pattern reflects the light in the light guide plate within a plane perpendicular to the light incident surface and the light exit surface to deflect the light in a direction perpendicular to the light exit surface little by little, and diffuses and reflects the light in the light guide plate within a surface parallel to at least the light incident surface is formed on a surface on the side opposite to the light exit surface of the light guide plate.

### BACKGROUND OF THE INVENTION

1. Technical Field

The present invention relates to area light source devices and liquid crystal display devices. More specifically, the present invention relates to an edge light type area light source device having a light emitting surface of a relatively large area that can be used in a backlight of a liquid crystal display, or the like, and a liquid crystal display device using such an area light source device.

2. Related Art

Japanese Unexamined Patent Publication No. 2005-108512 discloses the edge light type area light source device. FIG. 1A shows one example of an area light source device described in Japanese Unexamined Patent Publication No. 2005-108512. An area light source device 11 has a plurality of point light sources 13 (LED light sources) arranged facing an end face (light incident surface 14) of a transparent light guide plate 12, where a plurality of projections 16 is arranged on a light exit surface 15 of the light guide plate 12, and a groove 17 is formed on the surface opposite to the light exit surface 15 of the light guide plate 12. The projection 16 of the light guide plate 12 is formed to have a triangular cross-section, and extends in a direction perpendicular to the light incident surface 14 (hereinafter sometimes referred to as length direction of the light guide plate 12). Each projection 16 has the same shape, and is arrayed at an equal pitch along a direction parallel to the light incident surface 14 (hereinafter sometimes referred to as width direction of the light guide plate 12). The groove 17 of the light guide plate 12 has a V-groove shape as shown in FIG. 1B, and extends in a direction parallel to the light incident surface 14. The groove 17 has an equal shape, and is arrayed at a constant pitch along the length direction of the light guide plate 12.

In the area light source device 11 of such a structure, the light exited from the light guide plate 12 enters the light guide plate 12 from the light incident surface 14. The light guided through the light guide plate 12 (a light ray is represented by an arrow in the figure) is diffused in the width direction of the light guide plate 12 by being totally reflected by the projection 16 of the light exit surface 15, and is exited in a substantially perpendicular direction from the light exit surface 15 as shown in FIG. 1C by being reflected at an inclined surface 17a of the groove 17.

However, the spread (directivity characteristics) of the light exited from the light exit surface 15 becomes wide in the area light source device 11 having the structure shown in FIG. 1. Thus, in an area light source device 21 disclosed in Japanese Unexamined Patent Publication No. 9-113730, the directivity characteristics of the light exited from the area light source device 21 are narrowed by the structure shown in FIG. 2. In other words, the inclination angle of the inclined surface 17a is reduced and a prism sheet 22 is arranged facing the light exit surface 15. According to such a structure, since the inclination angle of the inclined surface 17a is small, the angle formed by the light guided through the light guide plate 12 and the normal line of the light exit surface 15 becomes small little by little every time the light is totally reflected at the inclined surface 17a, and the light is exited from the light exit surface 15 when the incident angle of the light entering the light exit surface 15 becomes smaller than the critical angle of total reflection. The light exited from the light exit surface 15 in such a manner exits in the direction where the angle formed by the light and the light exit surface 15 becomes smaller (i.e., direction substantially parallel to the light exit surface 15), and is collected in a narrow range in the plane perpendicular to the light exit surface 15. The light of narrow directivity characteristics exited in the direction substantially parallel to the light exit surface 15 is bent in a direction substantially perpendicular to the light exit surface 15 by the prism 22, and thus the light of narrow directivity characteristics is exited from the area light source device 21 in a substantially perpendicular direction.

The point light source 13 is shown in the area light source device 11 of FIG. 1, but a cold cathode tube may be used for the light source. Similarly, a cold cathode tube 23 is shown in the area light source device 21 of FIG. 2, but a plurality of point light sources may be used for the light source.

### SUMMARY

However, in a case where the point light source is used for the light source in the area light source device 11 disclosed in Japanese Unexamined Patent Publication No. 2005-108512 or in the area light source 21 disclosed in Japanese Unexamined Patent Publication No. 9-113730, a bright line appears in the vicinity of the point light source. FIG. 3 is a view (photograph) seen from the front surface showing the bright line that appeared in the area light source device in the vicinity of the point light source 13.

The bright line does not occur when the cold cathode tube is used in place of the plurality of point light sources, but the edge of the light exit surface brightly lights up entirely along the light incident surface with the cold cathode tube and the luminance unevenness may occur at the area light source device.

One or more embodiments of the present invention provides an area light source device and a liquid crystal display device capable of suppressing the occurrence of bright line and luminance unevenness as described above.

An area light source device according to one or more embodiments of the present invention relates to an area light source device including a light guide plate for spreading light introduced from a light incident surface to substantially the entire light exit surface and exiting the light to outside from the light exit surface, and a linear light source arranged facing the light incident surface of the light guide plate, wherein a diffusion pattern for diffusing and reflecting the light in the light guide plate within a surface parallel to the light incident surface is formed on the light exit surface of the light guide plate; and a deflection pattern for reflecting the light in the light guide plate within a plane perpendicular to the light incident surface and the light exit surface to deflect the light in a direction perpendicular to the light exit surface little by little, and for diffusing and reflecting the light in the light guide plate within a surface parallel to at least the light incident surface is formed on a surface on the side opposite to the light exit surface of the light guide plate. The linear light source according to one or more embodiments of the present invention includes a light source extending long in the width direction that faces the end face of the light guide plate such as the cold cathode tube, a plurality of point light sources arrayed in the width direction facing the end face of the light guide plate, a light source in which the light of the point light source is converted to a linear form with a wedge-shaped conductor, or the like.

In an area light source device according to one or more embodiments of the present invention, in the deflection pattern, a cross-sectional shape at a center cross-section parallel to the plane perpendicular to the light incident surface and the light exit surface includes an inclined portion inclined to become farther away from the light exit surface the closer to the light incident surface. The cross-section of the inclined portion is not limited to a straight line and may be curved. An inclination angle of the inclined portion is desirably greater than 0° and smaller than or equal to 20°.

In an area light source device according to one or more embodiments of the present invention, the deflection pattern has a shape in which a shape at the cross-section parallel to the light incident surface is curved. A slope of a tangent line defined to circumscribe the end of the curved shape is desirably greater than or equal to 23° and smaller than or equal to 70° at the cross-section of the deflection pattern. The condition for the slope of the tangent line does not need to be met at all the cross-sections of the deflection pattern but is desirably met at most of the cross-sections.

In an area light source device according to one or more embodiments of the present invention, the shape of the deflection pattern is substantially equal to one part of a circular cone shape.

In an area light source device according to one or more embodiments of the present invention, the diffusion pattern has an even cross-section along a direction perpendicular to the light incident surface, and a surface shape of the cross-section parallel to the light incident surface is a curved shape or a polygonal shape. The polygonal shape referred to herein excludes the diffusion pattern in which the cross-section has a triangular shape or a rectangular shape.

A liquid crystal display device according to one or more embodiments of the present invention includes a liquid crystal display and the area light source device according to one or more embodiments of the present invention.

According to one or more embodiments of the present invention, the light guided through the light guide plate can be diffused by the diffusion pattern and the deflection pattern, and the light can be enclosed in a narrow range and exited from the light exit surface of the light guide plate since the deflection pattern also has a function of diffusing light. As a result, the bright line and the luminance unevenness can be suppressed from occurring at the edge on the light source side of the light guide plate. The light enclosed in a narrow range and exited from the light exit surface can be bent toward the front surface direction of the area light source device by the prism sheet and exited, thereby further enhancing the front surface luminance of the area light source device.

### BRIEF DESCRIPTION OF THE DRAWINGS

FIG. 1A is a perspective view of an area light source device disclosed in Japanese Unexamined Patent Publication No. 2005-108512, FIG. 1B is a perspective view showing in an enlarged manner one part of a groove formed at the lower surface of a light guide plate used in the area light source device, and FIG. 1C is a schematic explanatory view showing a state in which light totally reflected at the inclined surface of the groove is exited from the light exit surface;

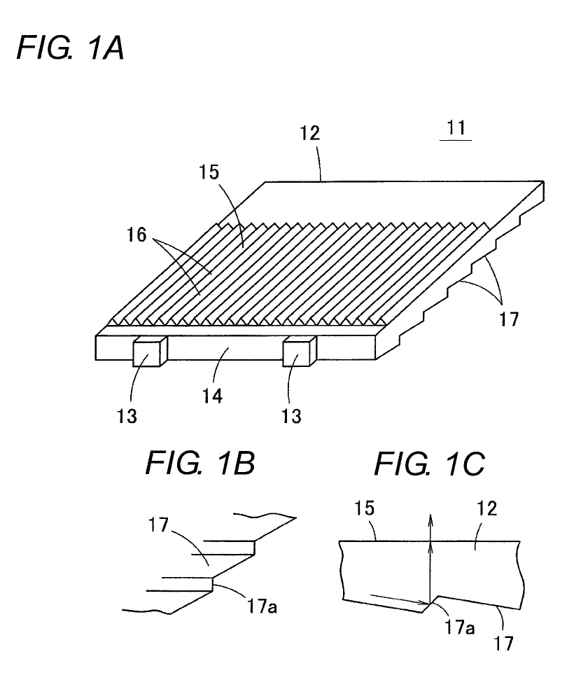

FIG. 2 is a perspective view of an area light source device disclosed in Japanese Unexamined Patent Publication No. 9-113730;

FIG. 3 is a view of the area light source device of FIG. 1, in which bright line occurred, seen from the front surface;

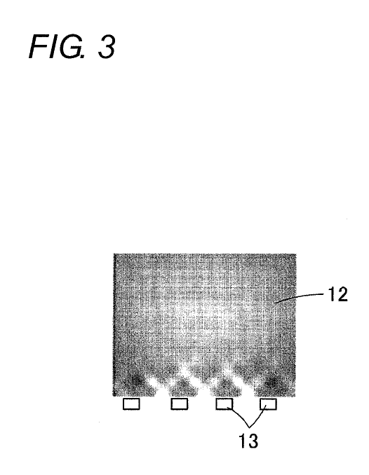

FIGS. 4A and 4B are a side view and a plan view showing a state in which the light is totally reflected at the lower surface of the light guide plate, FIGS. 4C to 4E are views showing the change in light vector by the vector diagram, and FIGS. 4F to 4H are views showing the movement of the light point in the vector diagram;

FIG. 5A is a cross-sectional view showing a state in which the light is totally reflected at the inclined surface of the light guide plate, FIG. 5B is a view showing the change in light vector by the vector diagram, and FIG. 5C is a view showing the movement of the light point in the vector diagram;

FIG. 6 is a schematic view showing the directivity characteristics of the light emitted from the light source, the light entered into the light guide plate, the light reflected at the lower surface of the light guide plate, and the light exited from the light exit surface of the light guide plate;

FIGS. 7A and 7B are views describing the vector diagram;

FIGS. 8A, 8B, and 8C are a schematic rear view, a schematic plan view, and a schematic side view showing the light guide plate formed with an inclined surface for every constant pitch at the lower surface, and FIGS. 8D, 8E, and 8F are views showing the vector diagram seen from the X direction, the Z direction and the Y direction;

FIGS. 9A, 9B, and 9C are a schematic rear view, a schematic plan view, and a schematic side view showing the light guide plate formed with a projection having a triangular cross-section on the upper surface, and FIGS. 9D, 9E, and 9F are views showing the vector diagram seen from the X direction, the Z direction and the Y direction;

FIGS. 10A and 10B are vector diagrams showing the behavior of light in the area light source device shown in FIG. 1, where FIG. 10A is a view of the vector diagram seen from the Y direction and FIG. 10B is a view of the vector diagram seen from the Z direction;

FIG. 11A is a schematic perspective view of the area light source device formed with the inclined surface for every constant pitch at the lower surface of the light guide plate, and FIG. 11B is a view showing the directivity characteristics of the light guided through the light guide plate while being reflected in the area light source device with the vector diagram;

FIG. 12A is a vector diagram showing the behavior of the light in the area light source device shown in FIG. 2, and FIG. 12B is a simplified display of FIG. 12A;

FIG. 13 is a perspective view of an area light source device according to a first embodiment of the present invention;

FIG. 14 is a view showing a deflection pattern formed at the lower surface of the light guide plate in the area light source device of the first embodiment;

FIG. 15A is a view showing in an enlarged manner one part of the cross-section parallel to the YZ plane of the light guide plate, and FIGS. 15B and 15C are an enlarged perspective view and a schematic cross-sectional view of the deflection pattern;

FIG. 16 is a perspective view of an area light source device according to a comparative example;

FIG. 17A is a vector diagram showing the behavior of the light in the comparative example, and FIG. 17B is a view in which one part is enlarged;

FIG. 18 is a vector diagram showing the behavior of the light in the area light source device of the first embodiment;

FIG. 19 is a view showing a state in which the bright lines are substantially resolved in the area light source device of the first embodiment;

FIGS. 20A and 20B are a cross-sectional view and an end face view of the deflection pattern used in the area light source device of the first embodiment;

FIG. 21 is a view showing the directivity characteristics of a general backlight;

FIGS. 22A and 22B are views describing the range of the inclination angle θ of the deflection pattern;

FIG. 23 is a view describing the basis of defining the range of the inclination angle φ of the deflection pattern;

FIG. 24 is a perspective view of an area light source device according to a second embodiment of the present invention;

FIGS. 25A to 25D are schematic views showing various cross-sectional shapes of the diffusion pattern;

FIGS. 26A and 26B are a perspective view and a cross-sectional view showing the deflection pattern recessed at the lower surface of the light guide plate; and

FIGS. 27A to 27E are a cross-sectional view or a bottom view showing various shapes of the deflection pattern.

### DETAILED DESCRIPTION

Hereinafter, embodiments of the present invention will be described, but prior to that, the vector diagram will be described as a tool for describing the effects of one or more embodiments of the present invention, and the reasons that the bright line and the luminance unevenness occur in the area light source devices of Japanese Unexamined Patent Publication No. 2005-108512 and Japanese Unexamined Patent Publication No. 9-113730 will be described using the vector diagram. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

(Description of Vector Diagram)

First, the vector diagram will be described. The vector diagram represents the light guiding direction of the light, where the light ray is shown with the light vector extending in a direction same as the direction of the light ray from the origin O. The distal end of each light vector is positioned on the same sphere in a medium where the index of refraction is constant since the length of the light vector is the same. The state of reflection and refraction of the light can be easily demonstrated by using such a vector diagram.

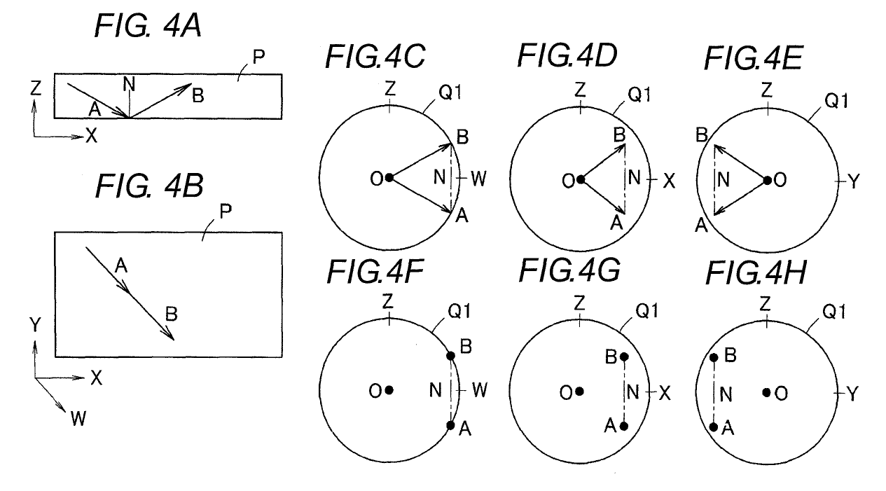

For instance, consider a case where light A guided through a light guide plate P is totally reflected at the flat bottom surface of the light guide plate P thereby becoming light B, as shown in FIGS. 4A and 4B. The direction perpendicular to the light incident surface of the light guide plate is the X direction, the direction perpendicular to the light exit surface of the light guide plate is Z direction, and the direction orthogonal to the X direction and the Z direction is the Y direction. The direction orthogonal to the Z direction in a plane including the lights A and B is the W direction.

When representing the incident light A and the reflected light B with the three-dimensional vector diagram, the light vector OA corresponding to the incident light A and the light vector OB corresponding to the reflected light B both have the base point of the light vector at the origin O and the distal end on the same spherical surface Q1. FIG. 4C is a view of the vector diagram seen from the direction perpendicular to the W direction and the Z direction, FIG. 4D is a view seen from the Y direction, and FIG. 4E is a view seen from the X direction. The distal end of the light vector OB is the point (intersection of normal line N and spherical surface Q1) where the distal end of the light vector OA is moved in a direction parallel to the normal line N in view of the fact that the lengths of the light vectors OA and OB are the same and that the angles formed by the incident light A and the incident light B with respect to the normal line N on the bottom surface are the same. Therefore, the direction of the reflected light can be easily recognized from the normal direction of the reflection surface by using the vector diagram.

The vector diagram can be an easier and clearer representation method by omitting the light vector and showing only the distal end since the base point of the light vector is always at the origin. FIGS. 4F to 4H show the light vectors OA, OB as light points A, B, thus showing the vector diagrams of FIGS. 4C to 4E in a simplified manner.

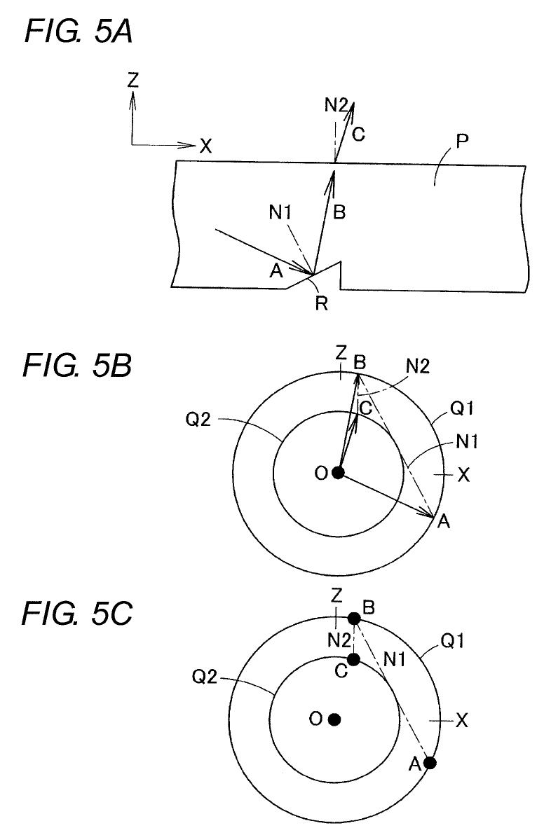

Now, consider a case where the incident light A is totally reflected at an inclined surface R provided at the bottom surface of the light guide plate P in the ZX plane, as shown in FIG. 5A. In this case, the reflected light B can be known as shown in FIG. 5B (vector diagram seen from Y direction). In other words, the light vector OA is drawn in the same direction as the incident light A, and line (N1) is extended from the distal end A of the light vector OA in the same direction as the normal line N1 of the inclined surface R, and the light vector OB having the intersection of such a line and the spherical surface Q1 as the distal end B is drawn.

Assuming the incident angle of the light B entering the upper surface of the light guide plate P is βi, the exit angle of the light exiting from the upper surface of the light guide plate P is βo, the index of refraction of the light guide plate P is n, and the index of refraction of the air is 1, the relationship n·sinβi=sinβo is met between the angles βi and βo. Therefore, in order to define the light vector OC of the refracted light C, the light vector OC of the exit light C can be known by drawing a spherical surface Q2 having a radius of 1/n of the spherical surface Q1, and obtaining the intersection of a normal line N2 of the upper surface of the light guide plate passing the distal end B of the light vector OB and the spherical surface Q2. FIG. 5C is a simplified form of FIG. 5B showing the light vectors OA, OB, OC as light points A, B, C. Thus, the direction of the reflected light and the exit light can be easily recognized from the normal direction of the reflection surface and the exit surface by using the vector diagram.

Hereinafter, a simple expression as shown in FIGS. 4F to 4H and FIG. 5C will be used to show the vector diagram.

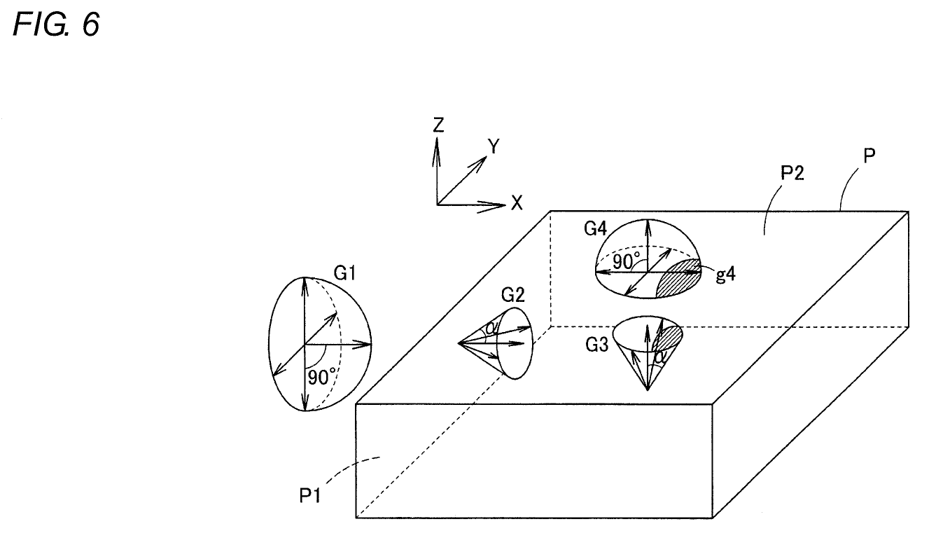

The relationship of the directivity characteristics of the light introduced to the light guide plate and the light ray direction exited from the light guide plate, and the vector diagram will be described with reference to FIG. 6. In FIG. 6, a linear light source (a plurality of point light sources or cold cathodes tubes) is arranged on the left side of the light guide plate P. The region in the direction of the light ray emitted from an arbitrary point of the linear light source is a hemisphere on the light guide plate side. In other words, the directivity characteristics of the light from an arbitrary point of the linear light source is a hemispherical surface in which the spread angle having the X direction as the center is 90° as shown with the directivity characteristics G1 in FIG. 6. When such light enters the light guide plate P from the light incident surface P, the directivity characteristics in the light guide plate P becomes a circular cone shape having the center in the X direction, as shown with the directivity characteristics G2 in FIG. 6 due to the refraction at the light incident surface P1. The directivity characteristics G2 has a spread angle of α=arcsin(1/n) having the X direction as the center. Here, n is the index of refraction of the light guide plate P.

If the light exit surface P2 of the light guide plate P is a plane, the light that can exit from the light exit surface P2 of the light totally reflected at the lower surface of the light guide plate P is in a range having a spread angel of α=arcsin(1/n) with the Z direction as the center, as shown with the directivity characteristics G3 in FIG. 6. When the light of such directivity characteristics G3 exits from the light exit surface P2, the directivity characteristics G4 in which the spread angle having the Z direction as the center is 90° is obtained as shown in FIG. 6.

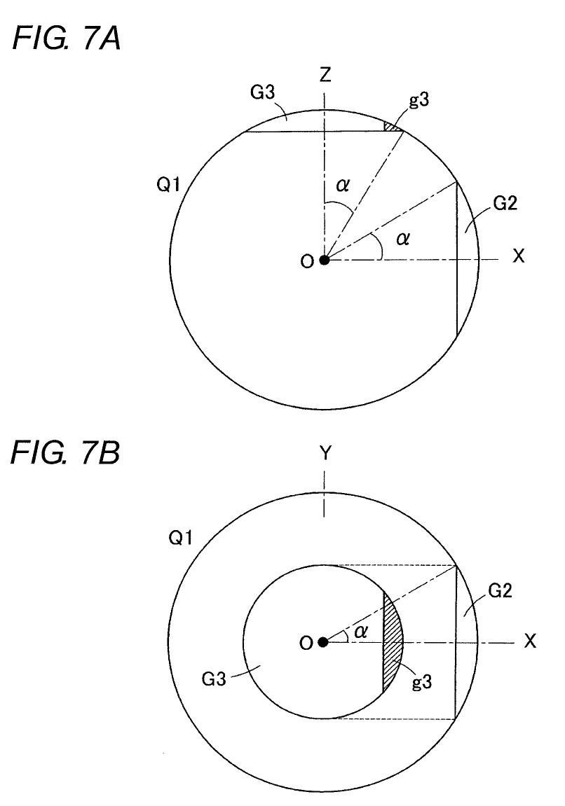

The directivity characteristics G2 becomes a spherical region G2 having the X direction as the center shown in FIGS. 7A and 7B when represented in vector diagram, and the directivity characteristics G3 becomes a spherical region G3 having the Z direction as the center. In other words, the light point of the light immediately after entering the light guide plate P is on the region G2, and the light corresponding to the light point totally reflected in the light guide plate P and moved onto the region G3 is exited to the outside from the light exit surface P2.

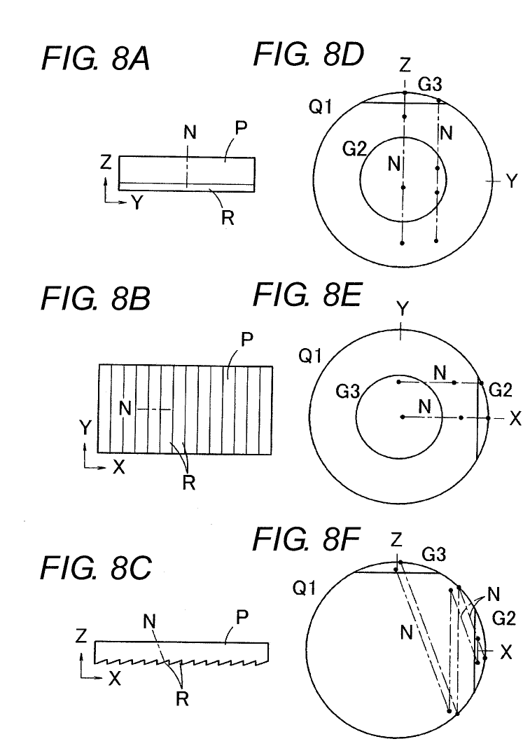

For instance, consider a case where the inclined surface R extending along the Y direction is formed at the lower surface of the light guide plate P, and the inclined surface R is lined at a constant pitch in the X direction, as shown in FIGS. 8A, 8B, and 8C. In this case, when the light is totally reflected at the upper surface and the inclined surface R of the light guide plate P so that the light point (light point is shown as a dot in the figure) on the region G2 reaches the region G3, as shown in FIGS. 8D, 8E, and 8F, such light is exited to the outside from the upper surface of the light guide plate P. FIGS. 8A and 8D are schematic views showing the light guide plate P and the vector diagram seen from the X direction, respectively, FIGS. 8B and 8E are schematic views showing the light guide plate P and the vector diagram seen from the Z direction, respectively, and FIGS. 8C and 8F are schematic views showing the light guide plate P and the vector diagram seen from the Y direction, respectively.

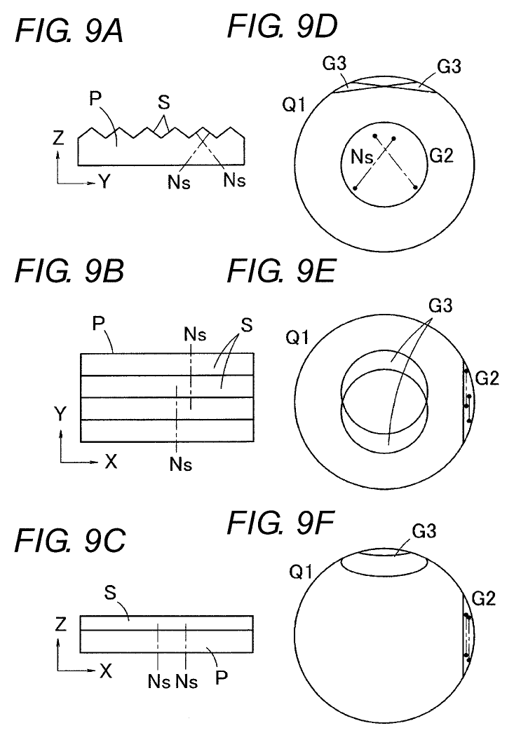

FIGS. 9A, 9B, and 9C show a case where a projection S for light diffusion is arranged on the upper surface (light exit surface) of the light guide plate P having a flat lower surface. The projection S with a triangular cross-section extends in the X direction, and is lined at every constant pitch along the Y direction. If a pattern is formed on the light exit surface such as in this case, a normal line on the flat light exit surface of before the pattern is formed (or light exit surface where each pattern is averaged and made flat) is called the normal line of the light exit surface. On the contrary, the normal line on the inclined surface configuring the projection S is called the normal line of the projection, as shown in FIGS. 9A to 9C. In this case, the light point in the region G2 of the vector diagram does not move to the region G3 side, as shown in FIGS. 9D to 9F since the normal line Ns of the projection S is parallel to the Y direction when seen from the Z direction. Therefore, the light in the light guide plate P is not exited to the outside from the light exit surface if the projection extending in the X direction is merely formed on the upper surface of the light guide plate P as shown in FIGS. 9A to 9C. FIGS. 9A and 9D are schematic views showing the light guide plate P and the vector diagram seen from the X direction, respectively, FIGS. 9B and 9E are schematic views showing the light guide plate P and the vector diagram seen from the Z direction, respectively, and FIGS. 9C and 9F are schematic views showing the light guide plate P and the vector diagram seen from the Y direction, respectively.

If the projection S having a triangular cross-section is arranged on the upper surface of the light guide plate P as shown in FIGS. 9A to 9F, the region G3 for exiting the light to the outside is separated into two regions as shown in FIG. 9E since the normal line Ns of the projection S is inclined in two directions from the normal direction (Z direction) of the light exit surface. Thus, the entire area of the region G3 seems to become wide and the light exit efficiency to become high. However, the light that entered the inclined surface of one slope of the projection S is exited to the outside but the light that entered the inclined surface of the other slope is totally reflected and again returned into the light guide plate in a region where the two regions G3 are not overlapping. Thus, there is no change in the exit efficiency as a whole, and hence the region G3 will be represented as one spherical region.

(Reasons that the Bright Line or the Like Occur in the Conventional Example)

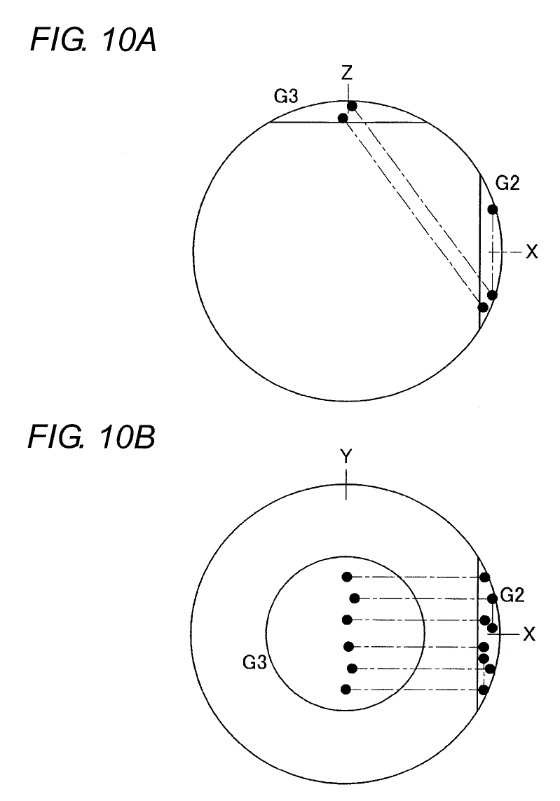

First, the reason that the bright line or the luminance unevenness occurs in the area light source device disclosed in Japanese Unexamined Patent Publication No. 2005-108512 will be described. In this case, the normal direction of the inclined surface is parallel to the X direction when seen from the Z direction, similar to FIGS. 8A to 8F, and furthermore, the inclination angle of the inclined surface is increased so that the light point of the region G2 move to the region G3 all at once as shown in FIGS. 10A and 10B, whereby the spread in the Y direction of the light exited from the light exit surface of the light guide plate becomes larger. Therefore, the amount of light that exits in the diagonal direction or the horizontal direction increases, and the bright line (case of point light source) or the luminance unevenness (case of cold cathode tube) occur in the area light source device.

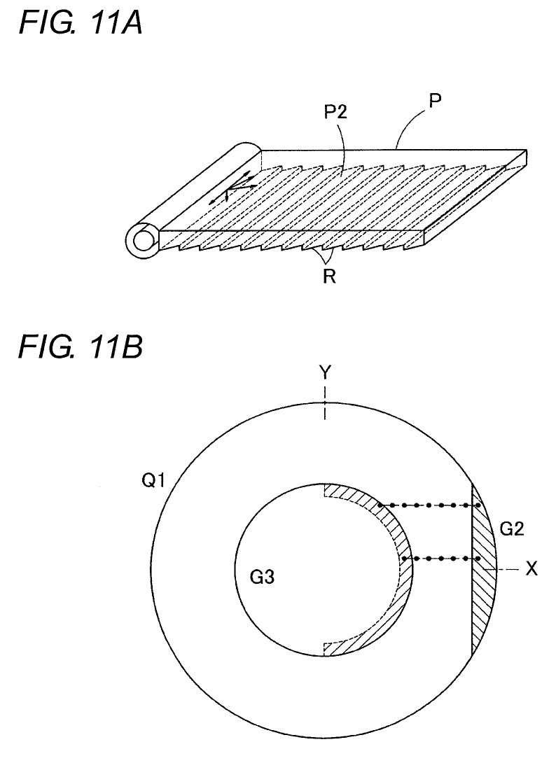

A method of exiting the light in a direction substantially parallel to the light exit surface P2 from the light exit surface P2, and converting the light exited in a direction substantially parallel to the light exit surface P2 to a direction substantially perpendicular to the light exit surface P2 by a prism sheet is described in Japanese Unexamined Patent Publication No. 9-113730 as a method of improving the area light source device of Japanese Unexamined Patent Publication No. 2005-108512. As one method, a method of reducing the slope of the inclined surface R at the lower surface of the light guide plate P so as to reduce the movement pitch of the light point, as shown in FIG. 11A, is disclosed in Japanese Unexamined Patent Publication No. 9-113730. However, if the light exit surface P2 is flat, as shown in FIG. 11A, the light point merely moves little by little in the direction parallel to the X direction as shown in FIG. 11B, and thus the light is exited from the light exit surface P2 in the shaded region of the region G3. Such light is exited in the direction substantially parallel to the light exit surface P2 from the light exit surface P2, but is spread in the width direction (Y direction) of the light guide plate P as shown in FIG. 11A. As a result, the bright line and the luminance unevenness cannot be resolved, and the front surface luminance lowers even if converted to the direction perpendicular to the light exit surface P2 with the prism sheet.

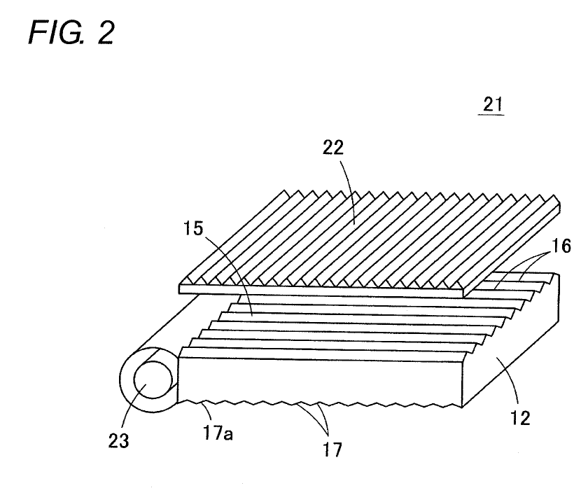

In order to exit the light in the direction substantially parallel to the exit surface P2 and to narrow the directivity characteristics, the light is to be exited in the shaded direction of the directivity characteristics G4 shown in FIG. 6, where the light reflected at the lower surface of the light guide plate P is gathered as much as possible in the shaded region g3 of the directivity characteristics G3 to realize the same. Thus, an inclined surface 17a having a small inclination angle is provided at the lower surface of the light guide plate 12 and a projection 16 for light diffusion is formed on the light exit surface 15 in the area light source device 21 (Japanese Unexamined Patent Publication No. 9-113730) shown in FIG. 2.

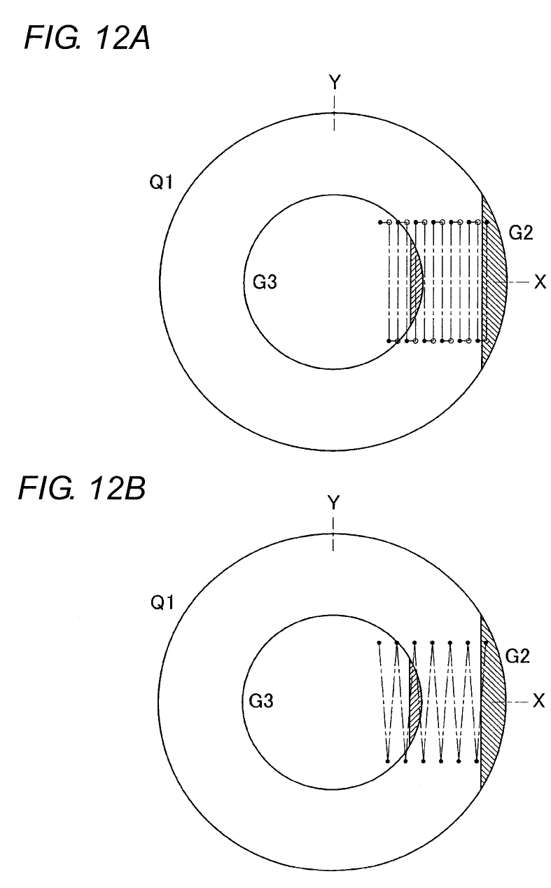

FIG. 12A is a vector diagram showing one example of the movement of the light point in the area light source device 21 shown in FIG. 2. The outlined arrow shows the light point after being reflected at the upper surface (projection 16) of the light guide plate, and the black circle shows the light point after being reflected at the lower surface (groove 17) of the light guide plate. However, since the outlined light point is the light vector toward the lower surface of the light guide plate, it does not need to be taken into consideration when considering the light exiting from the light exit surface. Therefore, only the light reflected at the lower surface of the light guide plate will be considered below. In the case of FIG. 12A, the outlined circle is omitted, and the black circles are directly connected as shown in FIG. 12B.

In the area light source device 21, the light point at the portion on the end of the region G2 can also reach the region g3 since the light can be diffused by the projection 16, and thus the light of narrow directivity (light in the shaded region g4 of the directivity characteristics G4 of FIG. 6) can be exited. However, the diffusion becomes regular since the projection 16 has a triangular cross-section, and the light point that reached the region other than the region g3 of the region G3 can be easily collected at a specific portion, as shown in FIG. 12B. Thus, the bright line and the luminance unevenness cannot be resolved in the area light source device 21. The front surface luminance of the light source device 21 is also desired to be further enhanced.

### First Embodiment of the Present Invention

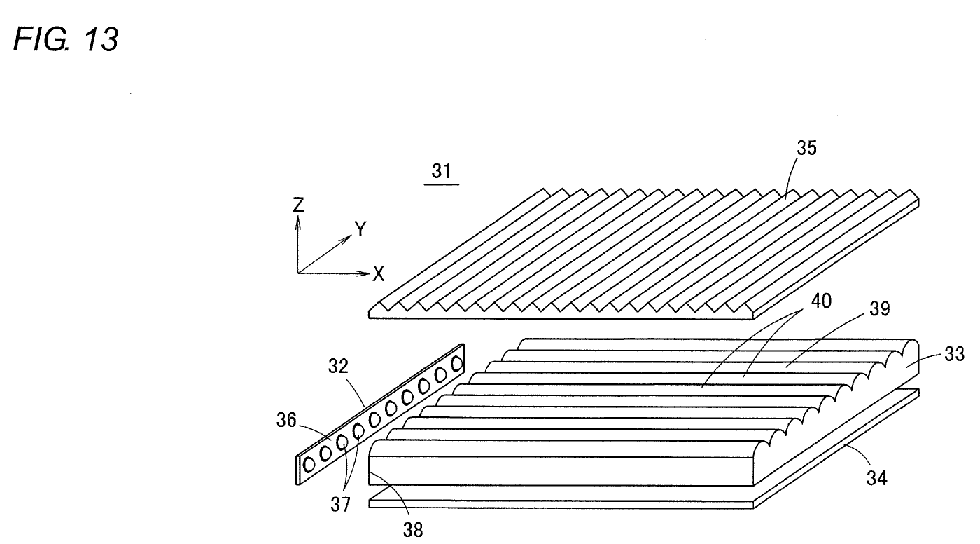

FIG. 13 is a schematic perspective view showing an area light source device 31 according to a first embodiment of the present invention. The area light source 31 includes a linear light source 32, a light guide plate 33, a light reflection plate 34, and a prism sheet 35. The linear light source 32 has a great number of (about a few dozen) point light sources 37 using LED mounted in a line on the surface of a circuit substrate 36, and is arranged facing a light incident surface 38 of a light guide plate 33.

A linear light source 32 including a great number of point light sources is shown in the illustrated example, but a cold cathode tube may be used for the linear light source 32. Although not shown in the figure, a wedge-shaped transparent conductor that is long in the inclined direction, a prism sheet, and one point light source may be used for the linear light source for introducing the light exited from the point light source into the wedge-shaped conductor and exiting the light from the elongate surface of the wedge-shaped conductor.

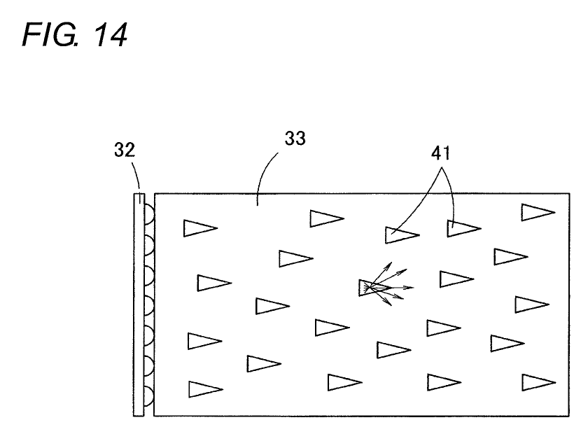

As shown in FIG. 14, the light guide plate 33 is formed by a translucent resin or glass having high index of refraction. The upper surface (light exit surface 39) and the lower surface of the light guide plate 33 are parallel, where a plurality of diffusion patterns 40 for light diffusion is formed on the upper surface, and a plurality of deflection patterns 41 is formed on the lower surface.

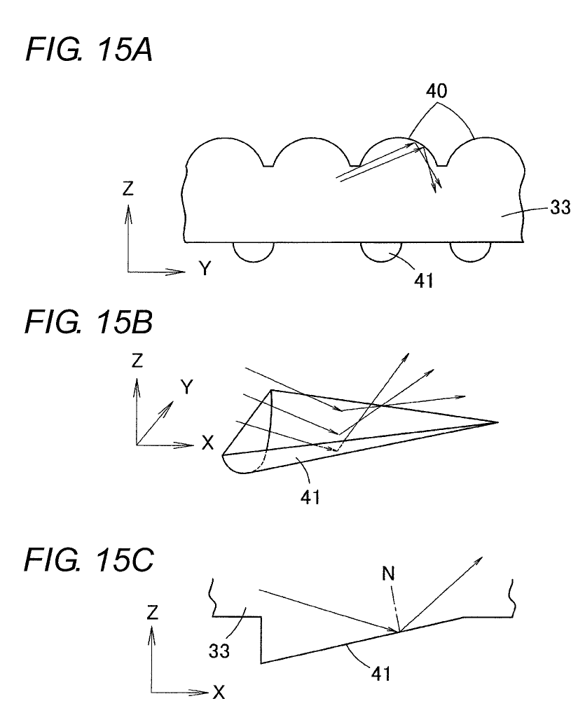

The diffusion pattern 40 has an even cross-section along the direction (X direction) perpendicular to the light incident surface 38, and is arrayed at a constant pitch along the width direction (Y direction) of the light guide plate 33. The diffusion pattern 40 has the surface curved to an arcuate shape as shown in FIG. 15A at the cross-section parallel to the YZ surface.

The light that entered the diffusion pattern 40 is totally reflected in different directions depending on the incident position in the YZ plane as shown in FIG. 15A and thus is diffused in the YZ plane. In the ZX plane, on the other hand, the light that entered the diffusion pattern 40 is reflected at the same angle as the incident angle with respect to the normal line of the light exit surface 39. Therefore, the light point of the light reflected at the diffusion pattern 40 randomly moves in the Y direction and the Z direction but does not move in the X direction on the vector diagram.

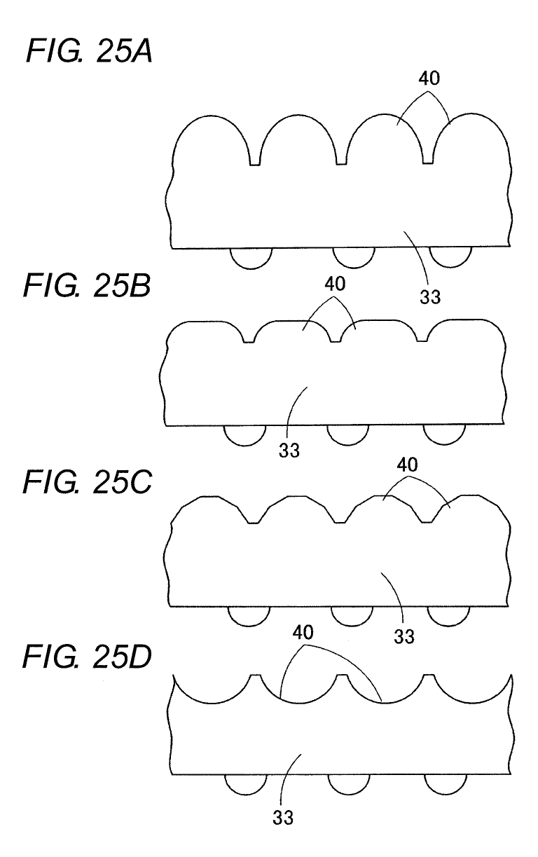

The diffusion pattern 40 merely needs to have a strong degree of diffusion of the reflected light in the YZ plane than the projection having a triangular cross-section, and is not limited to a surface having a semicircular shape or an arcuate shape. For instance, the diffusion pattern may have an elliptical cross-section as shown in FIG. 25A, or a flat cross-sectional shape as shown in FIG. 25B. Moreover, the diffusion pattern 40 may be formed to a polygonal cross-section in which the surface includes four or more planes, as shown in FIG. 25C. The diffusion pattern 40 may not necessarily be a projection, and the diffusion pattern 40 may be formed in the recess, as shown in FIG. 25D.

As shown in FIGS. 15B and 15C, the deflection pattern 41 projects out at the lower surface of the light guide plate 33, and has a shape as if the circular cone shape is divided to substantially half. Each deflection pattern 41 is arranged so that the center axis thereof is parallel to the X direction when seen from the Z direction, where the end face of a substantially semicircular shape is positioned on the side close to the light incident surface 38 and the distal end is positioned on the side distant from the light incident surface 38. Therefore, the deflection pattern 41 is a triangular projection having an inclined surface, as shown in FIG. 15C at the center cross-section parallel to the ZX plane. At the cross-section parallel to the YZ plane, the deflection pattern 41 is a substantially semicircular projection, where the cross-sectional shape of each cross-section parallel to the light incident surface 38 is a similar figure from each other. As the cross-sectional shape is a similar figure, the bias in the directivity becomes less in the YZ plane in the light deflected at each deflection pattern 41.

The light that entered the deflection pattern 41 is totally reflected in different directions depending on the incident position as shown in FIGS. 14 and 15B, and thus is scattered by the deflection pattern 41. In the ZX plane, the light that entered the diffusion pattern 40 is totally reflected in the direction where the angle with the normal line of the light exit surface 39 becomes smaller. Therefore, the light point of the light reflected at the deflection pattern 41 randomly moves in the Y direction and the Z direction and also moves little by little in the X direction on the vector diagram. Furthermore, the movement amount of the light point in the X direction is also random within a certain limit.

The light reflection plate 34 is arranged facing the lower surface of the light guide plate 33. The light reflection plate 34 is a high reflectance sheet such as a white resin sheet or a metal sheet, and acts to reflect the light leaked from the light guide plate 33 and return the light again to the light guide plate 33, thereby preventing the lowering of the light usage efficiency.

The prism sheet 35 has microscopic prisms having a triangular cross-section arrayed along the X direction. The light guide plate 33 exits the light of narrow directivity from the light exit surface 39 (e.g., exits the light in the shaded region g4 of the directivity characteristics G4 shown in FIG. 6), but such light does not contribute to the front surface luminance as it is directed in the direction substantially parallel to the light exit surface 39. Thus, if the light exited in the direction substantially parallel to the light exit surface 39 is entered to the prism sheet 35, the direction of the light can be converted to the direction substantially perpendicular to the light exit surface 39 and the light can be exited in the front surface direction of the area light source device 31.

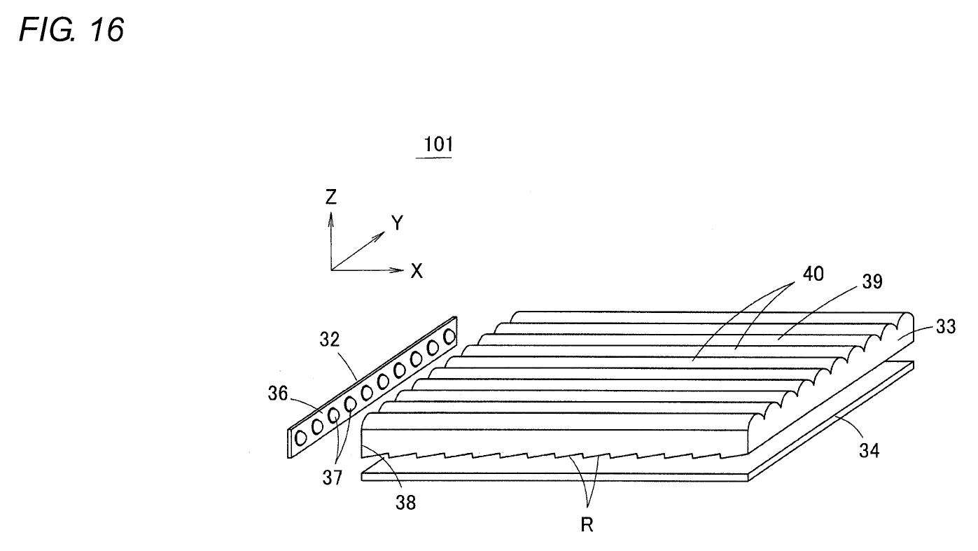

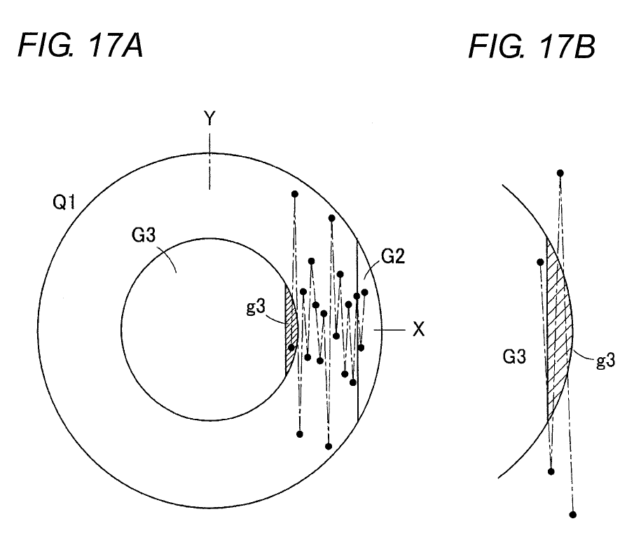

The effect of the area light source device 31 will now be described by comparing with an area light source device 101 serving as a comparative example of FIG. 16. The area light source device 101 of the comparative example of FIG. 16 differs from the area light source device 31 only in the pattern at the lower surface of the light guide plate 33. In the area light source device 101 of the comparative example, the pattern at the lower surface of the light guide plate 33 is a V-groove, and the inclined surface R (see FIG. 8) of small slope is lined in the X direction. The diffusion pattern 40 having an arcuate cross-section randomly moves the light point in the Y direction and the Z direction, but the inclined surface R merely moves the light point in the X direction little by little, and thus the movement of the light point in the vector diagram is as shown in FIG. 17A. The light point randomly moves in the Y direction and the Z direction by using the diffusion pattern 40 having an arcuate cross-section, and huts the light point in the region G2 easily enters the region g3 than in the case of the projection S of triangular cross-section (see FIG. 12), and the light exited from the light exit surface can be enclosed in a narrow range.

However, the manner of variation in the movement of the light point is still not sufficient in the area light source device 101 of the comparative example, and the light point may move across the region g3 and considerable light may enter the area other than the region g3 of the region G3, as shown in FIG. 17B. Thus, the light exited from the light exit surface other than from the region g3 becomes the cause of bright line and luminance unevenness. The front surface luminance of the area light source device 101 lowers due to the light that enters the area other than the region g3.

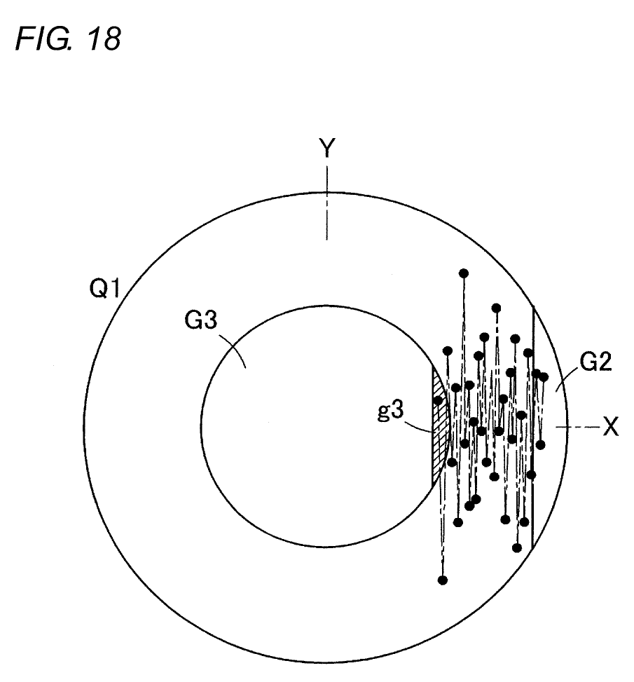

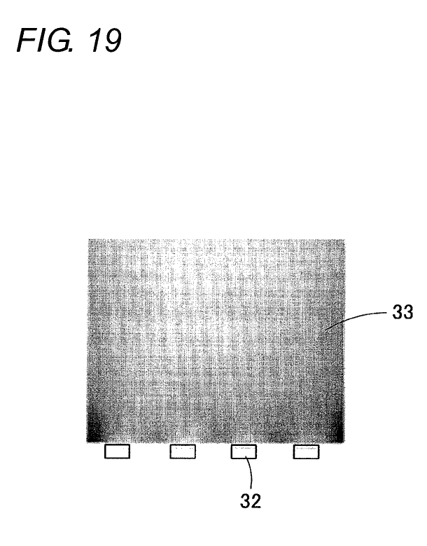

In the area light source device 31 of the first embodiment of the present invention, on the other hand, the light point randomly moves in the Y direction and the Z direction and also randomly moves in the X direction by the deflection pattern 41 as a result of diffusing the light with the deflection pattern 41 at the lower surface of the light guide plate 33. As a result, the movement of the light point in the vector diagram becomes more random as shown in FIG. 18. Furthermore, since the light is reflected at the deflection pattern 41 at the lower surface and scattered in the Y direction in the YZ plane, the light point of the light reflected at the deflection pattern 41 tends to be close to the ZX plane, and hence the light point easily moves to the opposite side across the ZX plane when reflected at the diffusion pattern 40 on the upper surface. As a result, the light point tends to easily enter the region g3. Therefore, the light exited from the light exit surface 39 is collected in the narrow region, and the bright line and the luminance unevenness are less likely to occur. Furthermore, the front surface luminance of the area light source device 31 can be enhanced by converting the light collected in the narrow range in the front surface direction with the prism sheet 35. FIG. 19 is a view (photograph) showing a state in which the bright line is alleviated in the area light source device 31 of the first embodiment of the present invention.

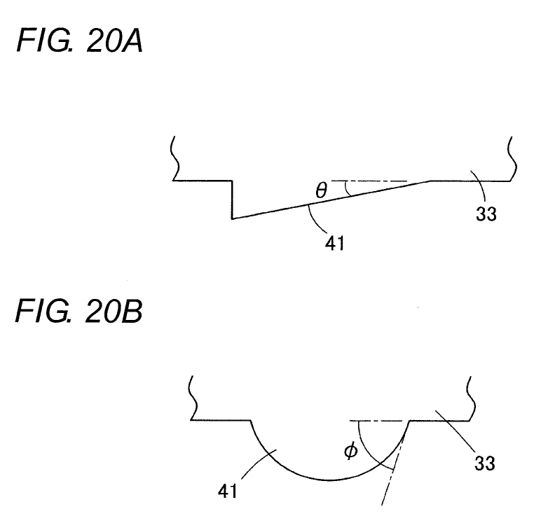

The conditions of the deflection pattern 41 at the lower surface will now be described. In other words, the maximum value of the inclination angle in the X direction of the deflection pattern 41 needs to be greater than 0° and smaller than or equal to 20°, and the maximum value of the slope of the tangent line circumscribing the surface of the deflection pattern 41 at the cross-section parallel to the YZ plane of the deflection pattern 41 needs to be greater than or equal to 23° and smaller than or equal to 70°. In the case of the deflection pattern 41 having a semicircular cone shape as shown in FIGS. 15B and 15C, the inclination angle θ at the cross-section parallel to the ZX plane passing the center of the deflection pattern 41 shown in FIG. 20A is 0°<θ≦20° (or θ≦20° and θ≠0°)

The angle (slope of tangent line) φ formed with the lower surface of the light guide plate 33 by the tangent line circumscribing to the end of the substantially semicircular cross-section (cross-section parallel to the YZ plane) of the deflection pattern 41 shown in FIG. 20B is to be 23°≦φ≦70°.
The slope φ of the tangent line does not need to satisfy the above condition at all cross-sections, but it is desired that the slope of the tangent line satisfies the above condition in most of the cross-sections.

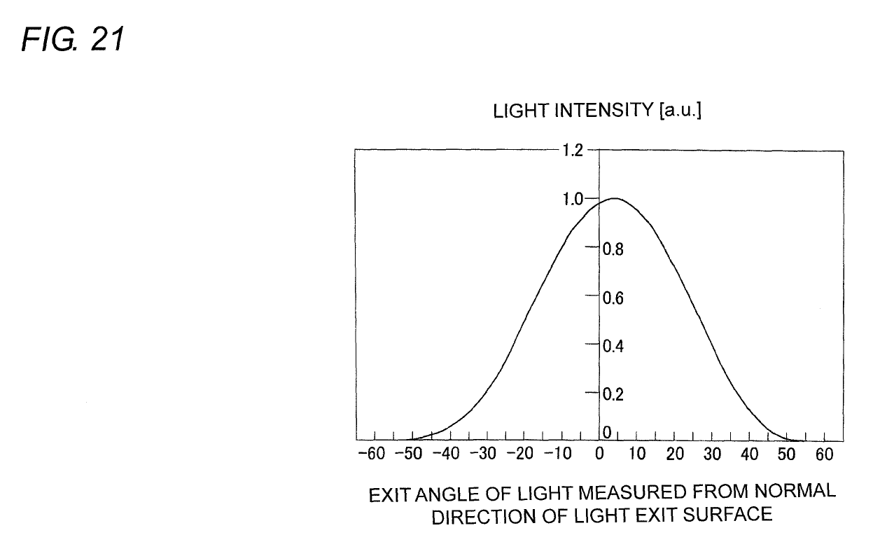

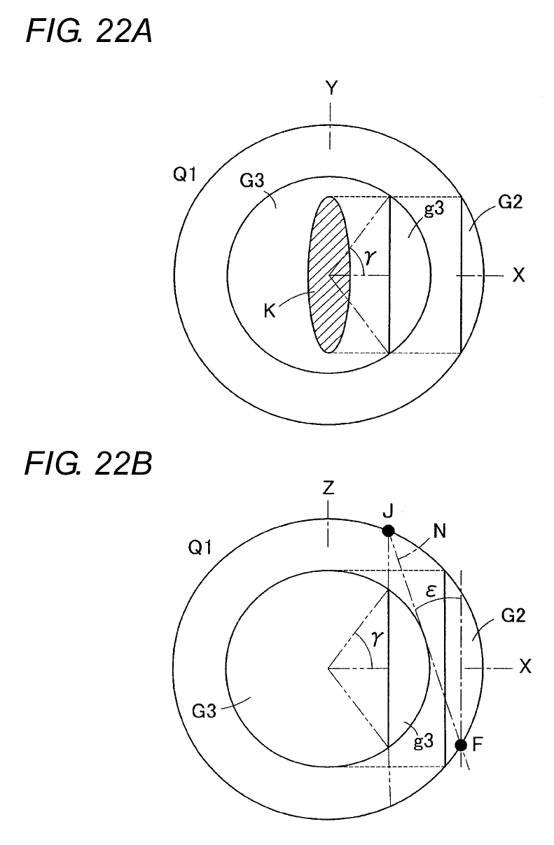

The reasons for the above are as follows. FIG. 21 is a view showing the directivity characteristics of a general back light. As apparent from the figure, the spread of the light exited from the area light source device needs to be smaller than or equal to 55° at a maximum. The region shown with shaded lines in FIG. 22A is the region of the light where the light of the region g3 is converted to the direction perpendicular to the light exit surface 39 by the prism sheet 35. The maximum spread angle of the region K is γ=55°. The region g3 of FIG. 22A is the region where the light points are to be collected in the region G3 so that the maximum spread angle γ of the region K is 55°. The spread of the region g3 becomes γ=55°. The following conditions are to be met in order to collect the light in the region g3. FIG. 22B shows a critical state for collecting the light in the region g3 in the ZX plane. In the ZX plane, assuming the point where the line extended parallel to the Z direction from the edge of the region g3 intersects the spherical surface Q1 as J, the condition that the light does not leak when seen from point J is that the angle ε formed with the Z direction when the movement direction JF of the light point circumscribes the spherical surface (region g3) on the inner side becomes a maximum value. If the angle ε formed by the tangent line (N) passing the point J and circumscribing the spherical surface of the region g3 and the Z direction is obtained, such an angle ε becomes about 20° (more specifically, 19.6°). The direction of the tangent lint (N) is parallel to the normal line N at the inclined surface of the deflection pattern 41, and thus the inclination angle θ of the deflection pattern 41 needs to be smaller than or equal to 20°. According to one or more embodiments of the present invention, θ≦10°. If the inclination angle θ is 0°, the light point does not move in the X direction but the light point moves in the X direction, in principle, if not 0°, and hence the inclination angle θ of the deflection pattern 41 is to be greater than 0° and, according to one or more embodiments of the present invention, greater than or equal to 1°. The optimum value of the inclination angle θ is about 3°.

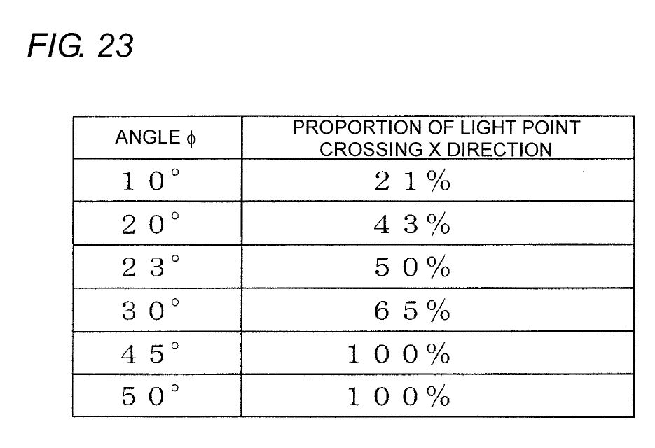

The light point of the light reflected at the deflection pattern 41 needs to move to the opposite side with the X direction in between when seen from the Z direction in the vector diagram for the light point of the region G2 to reach the region g3. FIG. 23 shows the result of obtaining the slope φ of the tangent line drawn at the end of the deflection pattern 41 and the proportion of the light point in which the light point moves to the opposite side across the X direction through simulation. Since at least half or more of the light points need to cross the X direction, the slope φ of the tangent line needs to be greater than or equal to 23° and, according to one or more embodiments of the present invention, greater than or equal to 30°, and, according to one or more embodiments of the present invention, greater than or equal to 45°, according to the result of FIG. 23. The light does not enter the side surface of the deflection pattern 41 when the slope φ of the tangent line approaches 90°, and thus the slope φ of the tangent line needs to be smaller than or equal to 70°. Therefore, the slope φ of the tangent line drawn at the end of the deflection pattern 41 needs to be greater than or equal to 23° and smaller than or equal to 70°. The optimum value of the slope φ is about 60°

Not all the deflection patterns 41 need to satisfy the conditions of the inclination angles θ, φ, and at least 70% or more or, according to one or more embodiments of the present invention, 80% or more of the entire number of patterns merely need to satisfy the conditions.

### Second Embodiment of the Present Invention

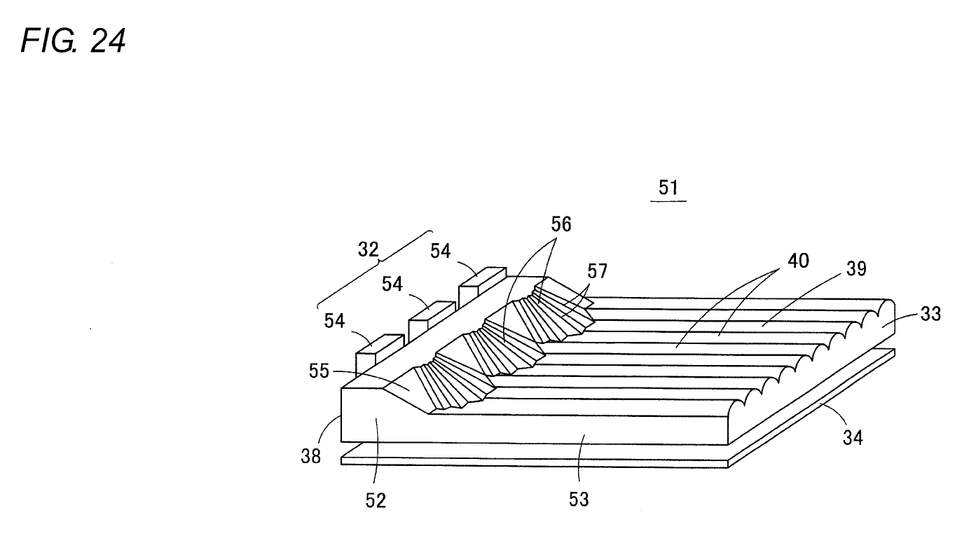

FIG. 24 is a perspective view showing an area light source device 51 according to a second embodiment of the present invention. The area light source device 51 includes a light introducing portion 52 having a larger thickness than the light guide plate main body 53 at the end of the light guide plate main body 53, thereby thinning the light guide plate main body 53 occupying the majority of the light guide plate 33. The light guide plate main body 53 has a structure similar to the light guide plate 33 of the first embodiment. (The illustration of the prism sheet 35 arranged facing the light guide plate main body 53 is not shown in FIG. 24).

Since the height of the light source is limited, the light that becomes a loss without entering the light guide plate from the light incident surface increases and the usage efficiency of the light worsens if the thickness of the light guide plate is thinned. Thus, the light introducing portion 52 having a large thickness is arranged at the end of the light guide plate main body 53, and the linear light source 32 is arranged facing the end face (light incident surface 38) of the light introducing portion 52 in the area light source device 51. The thickness of the light introducing portion 52 is desirably thicker than the height of the light exit surface of the light source.

The inclined surface 55 is formed between the upper surface of the light introducing portion 52 and the upper surface of the light guide plate main body 53, but the light easily leaks from the inclined surface 55 if the inclination angle of the inclined surface 55 becomes large, and the light that entered the light introducing portion 52 cannot be efficiently guided to the light guide plate main body 53. Thus, a circular cone shaped surface 56 is formed along the inclined surface 55 at the front side of each point light source 54 arranged in the linear light source 32, and a V-groove pattern 57 is formed substantially radially along the inclined direction at the surface of the circular cone shaped surface 56. The directivity characteristics of the light can be converted by totally reflecting the light in the light introducing portion 52 with the V-groove pattern 57 arranged at the inclined surface 55 or the circular cone shaped surface 56, and the light can be guided to the light guide plate main body 53 without leaking the light from the inclined surface 55. According to the second embodiment, the usage efficiency of the light of the light source can be enhanced while thinning the light guide plate 33 in addition to the effects of the first embodiment.

The operation of the light introducing portion 52 and the V-groove pattern 57 at the circular cone shaped surface 56 in the second embodiment is described in detail in Japanese Patent Application No. 2008-209832 (or PCT/JP2009/003435).

### Other Embodiments

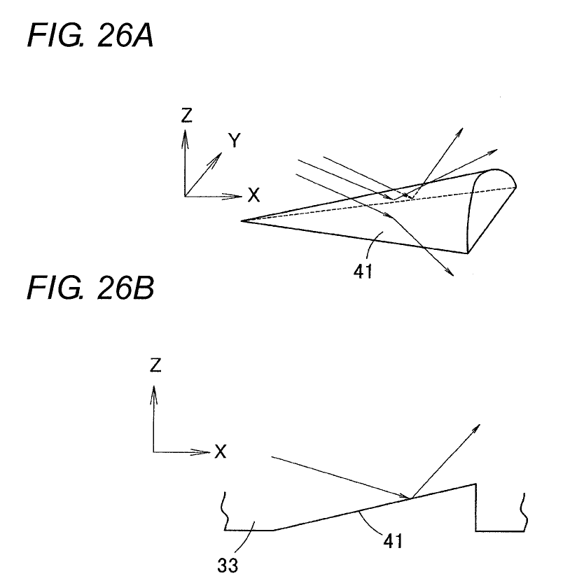

The present invention is not limited to the above embodiments, and various design changes can be made within a scope of the present invention. For instance, the deflection pattern 41 is projected out at the lower surface of the light guide plate 33 in the above embodiments, but may be recessed at the lower surface of the light guide plate 33, as shown in FIGS. 26A and 26B. In this case, the 41 having a shape of dividing the circular cone shape in half is arranged so that the distal end is on the side close to the light incident surface and the semicircular end face is on the side far from the light incident surface.

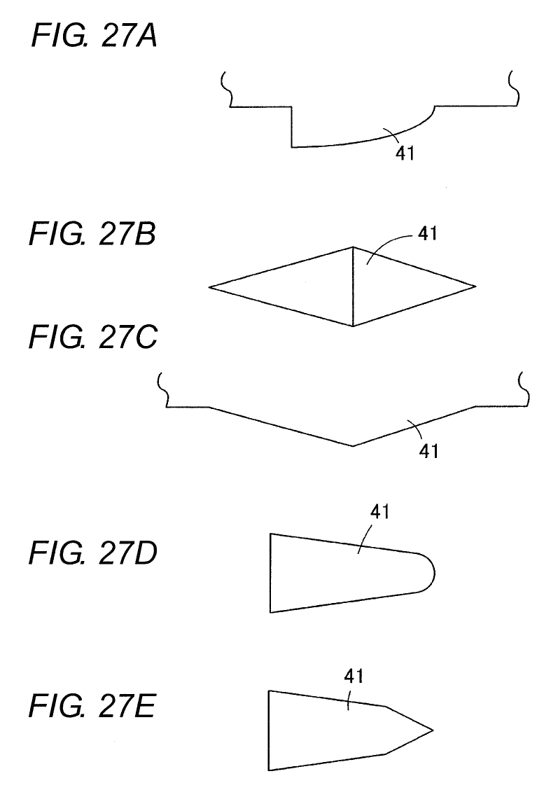

As shown in FIG. 27, various shapes can be considered for the shape of the deflection pattern 41. In FIG. 27A, the cross-section in the X direction is curved. In FIGS. 27B and 27C, two objects having a semicircular cone shape are connected. In FIG. 27D, the deflection pattern 41 has a rounded distal end, and in FIG. 27E, the deflection pattern 41 has a polygonal distal end. Furthermore, the portion where the light barely enters in the deflection pattern 41 may be any shape.

The area light source device according to one or more embodiments of the present invention is used as an area light source device having a relatively large area, and can be used as a backlight of a liquid crystal display or the like mounted on a notebook computer.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An area light source device comprising:
a light guide plate comprising a light incident surface and a light exit surface, wherein the light guide plate spreads light introduced from the light incident surface to substantially the entire light exit surface, and exits the light to outside from the light exit surface; and
a linear light source arranged facing the light incident surface of the light guide plate, wherein
a diffusion pattern diffuses and reflects the light in the light guide plate within a surface parallel to the light incident surface is formed on the light exit surface of the light guide plate; and
a deflection pattern reflects the light in the light guide plate within a plane perpendicular to the light incident surface and the light exit surface to deflect the light in a direction perpendicular to the light exit surface little by little, and diffuses and reflects the light in the light guide plate within a surface parallel to at least the light incident surface is formed on a surface on the side opposite to the light exit surface of the light guide plate.

2. The area light source device according to claim 1, wherein in the deflection pattern, a cross-sectional shape at a center cross-section parallel to the plane perpendicular to the light incident surface and the light exit surface includes an inclined portion inclined to become farther away from the light exit surface the closer to the light incident surface.

3. The area light source device according to claim 2, wherein an inclination angle of the inclined portion is greater than 0° and smaller than or equal to 20°.

4. The area light source device according to claim 1, wherein the deflection pattern has a shape in which a shape at the cross-section parallel to the light incident surface is curved.

5. The area light source device according to claim 4, wherein a slope of a tangent line defined to circumscribe an end of the curved shape is greater than or equal to 23° and smaller than or equal to 70° at the cross-section of the deflection pattern.

6. The area light source device according to claim 2, wherein the shape of the deflection pattern is substantially equal to one part of a circular cone shape.

7. The area light source device according to claim 4, wherein the shape of the deflection pattern is substantially equal to one part of a circular cone shape.

8. The area light source device according to claim 1, wherein the diffusion pattern has an even cross-section along a direction perpendicular to the light incident surface, and a surface shape of the cross-section parallel to the light incident surface is a curved shape or a polygonal shape.

9. A liquid crystal display device comprising a liquid crystal display and the area light source device according to claim 1.
